(19) United States
(12) Patent Application Publication
(10) Pub. No.: US 2008/0181264 A1
(43) Pub. Date: Jul. 31, 2008

(54) LASER LIGHT SOURCE DEVICE

(75) Inventors: Yosuke MIZUYAMA, Fukuoka (JP); Shogo HORINNOUCHI, Fukuoka (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., Osaka (JP)

(21) Appl. No.: 12/021,150

(22) Filed: Jan. 28, 2008

(30) Foreign Application Priority Data
Jan. 29, 2007 (JP) 2006-017923

(51) Int. Cl. H01S 3/10

(52) U.S. Cl. 372/20

(57) ABSTRACT

A laser light source device includes: a laser light source, a first optical device that returns some of a beam emitted from the laser light source so as to induce oscillation at a particular wavelength between some of the beam and the laser light source so that the beam emitted from the laser light source becomes close to a single wavelength, and reflects other portion of the emitted beam, a second optical device that forms an interference fringe from a reflected beam from the first optical device, a beam detection unit that detect a main wavelength of a plurality of wavelengths included in a beam derived from the second optical device and detects an ununiform state of the plurality of wavelengths, a partial reflection mirror that transmits some of the reflected beam from the first optical device to the second optical device and reflects the other portion of the reflected beam toward a recording medium, an optical member that integrally includes the first optical device, the second optical device and the partial reflection mirror, and a driving unit that changes a position of the optical member.

### BACKGROUND

The present invention relates to a laser light source device, and more particularly, to improvement of a laser light source device used for hologram recording and reproduction.

In recent years, a hologram recording technique has been developed as one of techniques for using light to record a mass of information. As hologram recording allows information to be three-dimensionally recorded in a medium by transforming the information into an interference fringe, thereby providing possibility of achievment of mass recording capacity of 1 tera-byte or so, with expectations for the next generation recording technique following Blue-ray optical disk recording devices. A recorded interference fringe may be reproduced as original information using reproducing light, which is called ‘information reproduction.’

Here, the principle of hologram recording using spatial modulation will be described in brief. For recording, first, information is converted into light that is spatial-modulated by means of SLM (Spatial Light Modulator) or the like, which is called ‘object light.’ Next, reference light, which propagates along a path different from that of the object light, interferes with the object light in a recording medium. Thus, an interference fringe is formed as information, generally with distribution of refractive index of the recording medium, in the recording medium. For reproducing, the interference fringe in the recording medium is irradiated with the original reference light, and thus diffracted light is spatial-modulated into an image, thereby reproducing data.

As mentioned above, the hologram recording uses the interference fringe. Accordingly, it goes without saying that coherence of a light source producing the interference fringe is important for the hologram recording. The object light and the reference light are preferably originated from a single light source on the demand for compactness and alignment of an optical system, although they may be originated from separate light sources. In this case, contrast of the interference fringe formed by the recording is determined by the coherence of the light source. The contrast of the interference fringe is one of factors important in determining sensitivity of a recording apparatus. Lower contrast, which means a lower S/N ratio of an electrical signal into which information is converted, makes it more difficult to design a system, which results in narrower use and higher costs of the system.

Accordingly, high coherence is indispensable for the hologram recording. Coherence of light has the same meaning as a single wavelength or a narrow frequency band. That is, the hologram recording requires light to have a single wavelength as possible. A state of oscillation with a single wavelength is called ‘single mode,’ while a state of oscillation with plural wavelengths is called ‘multi-mode.’ Accordingly, a laser with the single mode is required for the hologram recording.

In addition, for the hologram recording, since interference conditions of a interference fringe recorded in a recording medium may be varied depending on a difference in ambient temperature between recording and reproducing, the reproducing may be, in some cases, impossible even with the same wavelength as the recording. In such cases, there is a need to make hologram reproducing by adjusting a wavelength of a light source. As a result, it can be said that the hologram recording requires a wavelength-tunable single mode laser.

Typically, an example of a coherent light source may include lasers such as a gas laser, a liquid laser, a solid laser, a semiconductor laser and the like. Since the gas laser and the liquid laser generally have a large resonator and can generate a good single mode, they are suitable for hologram recording. However, since these lasers are large in scale and high in costs, they are inapplicable to hologram recording apparatuses for mass production. On the other hand, since the semiconductor laser, which is also called ‘diode laser,’ has a small resonator and is inexpensive, this laser is appropriate for mass production. However since this laser oscillates with a multi-mode, it cannot be used as such for a hologram recording apparatus.

Under the above circumstances, there has been conventionally developed a so-called wavelength-tunable external cavity diode laser that is attached with an external resonator to generate a single mode and can make an oscillation wavelength tunable, as disclosed in, for example, Patent Document 1, Patent Document 2, and Non-Patent Document 1, which are listed below.

These documents disclose a technique for generating a single mode by combining a diode laser with a diffraction grating and a technique for continuously changing a wavelength by combining a diffraction grating with an external resonator mirror. In such a conventional technique disclosed in the above Patent Document 1, Patent Document 2 and Non-Patent Document 1, laser oscillation is made as follows. Ablaze diffraction grating is arranged as an external resonator mirror at a fore facet of a tip in the outer side of a diode chip. The blaze diffraction grating receives a beam having a certain wavelength band, which is incident from a diode laser and selectively emits diffracted light having an order defined by predetermined diffraction efficiency and having a certain wavelength narrower than that of an incident beam defined by a characteristic of the diffraction grating. The diffraction light is fed back to the diode laser with a particular arrangement of a Littman type or a Littrow type. In this manner, a new external resonant path is created between the diffraction grating and a rear facet of the diode laser) and laser oscillation is selectively made by the defined diffracted light along the external resonant path. When a resonant wavelength of this external resonator, a resonant wavelength of a resonator of the diode laser, and a wavelength of the diffracted light selected by the blaze diffraction grating becomes equal to each other, single mode oscillation at that wavelength is realized. By using diffraction efficiency of the blaze diffraction grating) which is not completely 100%, the diffraction grating performs a role of an output coupler, and the diffracted light in combination with zero-order light is emitted out of the external resonator. Thus, single mode laser oscillation is obtained from the diode laser which typically has the multi-mode.

In addition, since an incident angle of a beam can be adjusted by rotating the blaze diffraction grating by means of a rotating mechanism, it is possible to select any wavelength in a range of wavelength band of the diode lasers. Typically, the external resonator is considerably longer than the resonator of the diode laser. Accordingly, provision of a new external resonant path allows an oscillation mode minuter than the oscillation mode of the diode laser. The light randomly selected by angle adjustment of the blaze diffraction grating can be oscillated in one of oscillation modes arranged at minute wavelength intervals by the external resonator. In this manner, a wavelength-tunable single mode laser can be obtained from a multi-mode laser.

In addition, Non-Patent Document 2 discloses a configuration where a wavelength is tuned by adjusting a rotating angle and a position of a blaze diffraction grating in the same Littman type arrangement as the above example.

In addition, Patent Document 3, Patent Document 4 and Non-Patent Document 3 disclose a laser light source device including an external resonator with Littrow arrangement, a blasé diffraction grating, a mode hop sensor composed of an optical wedge and a set of detectors, and a wavelength monitor composed of a prism and a set of detectors.

[Patent Document 1] U.S. Pat. No. 5,867,512

[Patent Document 2] U.S. Patent Application Publication No. 2005/0163172

[Patent Document 3] Japanese Unexamined Patent Application Publication No. 2006-114183

[Patent Document 4] U.S. Patent Application Publication No. 2006/0114535

[Non-Patent Document 1] “Spectroscopy with Diode Lasers” http://data.sacher-laser.com/techdocs/D1spec.pdf

[Non-Patent Document 2] “Construction of an external cavity type wavelength-tunable diode laser system” http://www.osakac.ac.jp/erc/science/38/tomioka.pdf

[Non-Patent Document 3] “Tunable blue laser for holographic data storage,” Conference Proceedings of the OSD2006 Topical Meeting

However, the above-mentioned conventional techniques have the following problems. In the laser light source apparatuses as shown in Patent Document 3, Patent Document 4 and Non-Patent Document 3, since a plurality of optical devices such as the blaze diffraction grating, the optical wedge, the prism and the like are arranged separately, irregularity of relative position between the optical devices is likely to increase, and it may take a long time to adjust the relative position between the optical devices.

### SUMMARY

The present invention has made to overcome the above problems and it is an object of the present invention to provide a laser light source device which is capable of reducing irregularity of relative position between optical devices and which is high in precision and low in costs.

The present invention provides a laser light source device including: a laser light source that emits a laser beam, a first optical device that returns some of a beam emitted from the laser light source so as to induce oscillation at a particular wavelength between some of the beam and the laser light source so that the beam emitted from the laser light source becomes close to a single wavelength, and reflects other portion of the emitted beam, a second optical device that forms an interference fringe from a reflected beam from the first optical device, a beam detection unit that detect a main wavelength of a plurality of wavelengths included in a beam derived from the second optical device and detects an ununiform state of the plurality of wavelengths, a partial reflection mirror that transmits some of the reflected beam from the first optical device to the second optical device and reflects the other portion of the reflected beam toward a recording medium, an optical member that integrally includes the first optical device, the second optical device and the partial reflection mirror, and a driving unit that changes a position of the optical member.

With this configuration, by integrating the first optical device, the second optical device, and the partial reflection mirror, which are main parts, in a single member, it is possible to reduce ununiformity of relative position between the optical devices with high precision and low costs.

### BRIEF DESCRIPTION OF THE DRAWINGS

FIG. 1 is a view showing an external cavity type laser light source device according to a first embodiment.

FIGS. 2(a) to 2(c) are views showing an external cavity type laser light source device according to a first embodiment.

FIG. 3 is a view showing a prism according to a first embodiment.

FIG. 4 is a view showing a contour line of an astigmatic Fresnel mirror according to a first embodiment.

FIG. 5 is a view showing a pattern of an interference fringes according to a first embodiment.

FIG. 6 is a view showing a diffraction gating pattern for laser beam split according to a first embodiment.

FIG. 7 is a view showing a detector pattern of a beam detection means according to a first embodiment.

FIG. 8 is a view showing an external cavity type laser light source device according to a second embodiment.

FIG. 9 is a view showing an external cavity type laser light source device according to a second embodiment.

FIG. 10 is a view showing an external cavity type laser light source device according to a third embodiment.

FIG. 11 is a view showing an oscillation mode according to an embodiment.

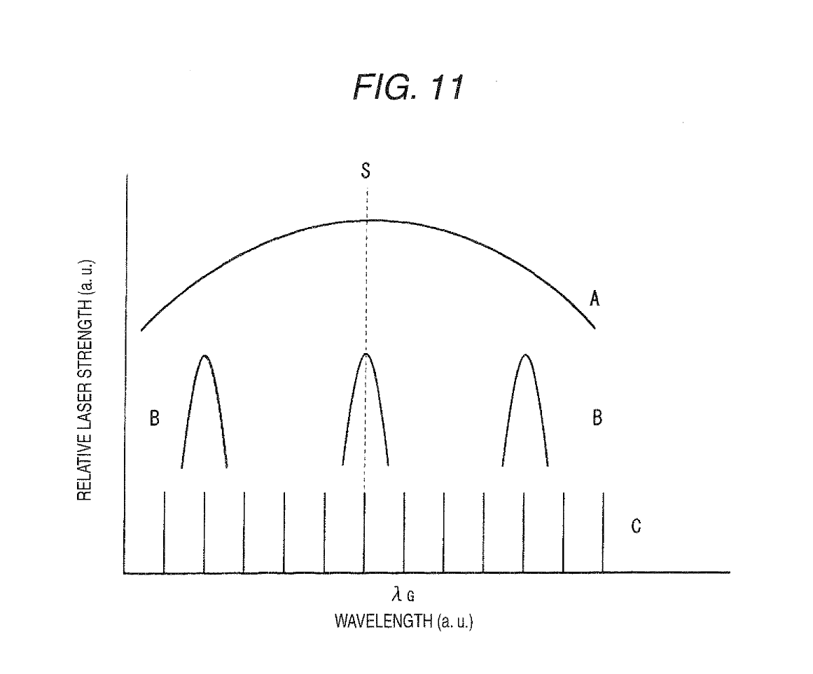

FIG. 12 is a view showing a conventional external cavity type laser light source device.

FIG. 13 is a view showing an oscillation mode in a conventional external cavity type laser light source device.

FIG. 14 is a view showing an oscillation mode in a conventional external cavity type laser light source device.

FIG. 15 is a view showing an oscillation mode in a conventional external cavity type laser light source device.

FIG. 16 is a view showing an oscillation mode in a conventional external cavity type laser light source device.

### DETAILED DESCRIPTION

### First Embodiment

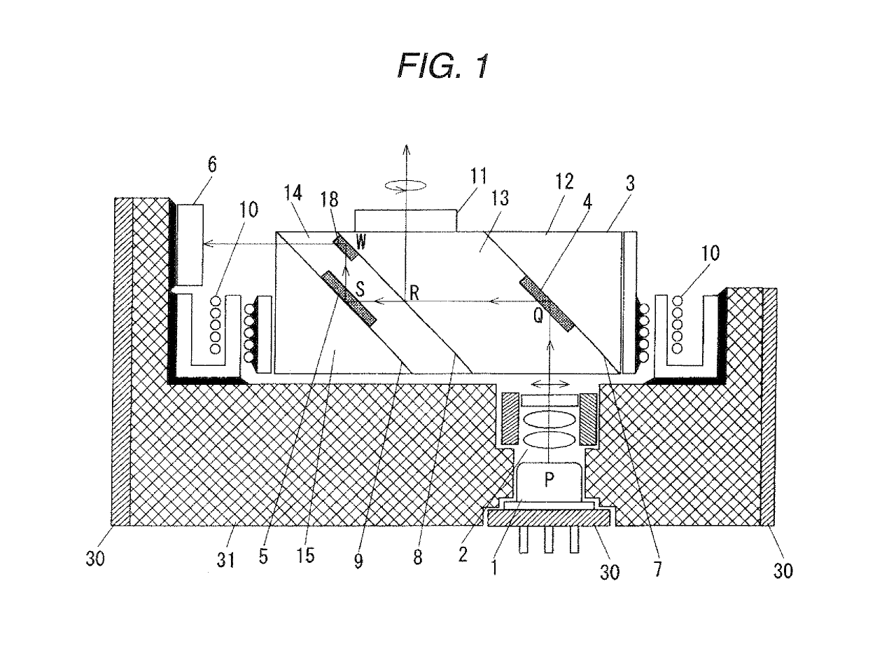

A laser light source device according to a first embodiment will be described with reference to FIG. 1 showing an external cavity type laser light source device. A laser used herein is an available semiconductor laser with a wavelength of 405 nm and power of 150 mW. The semiconductor laser has a resonator of length of 600 μm and outputs a linearly-polarized laser beam having a horizontal divergence half-value angle of 9° and a vertical divergence half-value angle of 21°. A multi-mode laser beam emitted with a predetermined divergent angle from a semiconductor laser 1 is incident into a third optical device 2. The third optical device 2 is composed of, for example, two lenses, and one of which is an optical device for collimating a divergent beam into a parallel beam. Since a divergent angle of the semiconductor laser in a horizontal direction is different from that in a vertical direction, a beam shape generally having uniform strength is elliptical. In addition, a strength distribution is generally close to a Gaussian distribution. The other lens of the third optical device 2 converts an elliptical laser beam into a circular beam. This allows use of a detection system by a method of recognizing a beam shape. In addition, the other lens of the third optical device 2 may have the function of beam-shaping a Gaussian distribution into a flat top distribution. Thus, it is possible to significantly increase efficiency of multi-recording as compared with a Gaussian strength distribution. The third optical device 2 may have either both of the collimation function and the beam shaping function or only the collimation function. The number of lenses may be either one or two.

The laser beam passed through the third optical device 2 is incident into a prism 3. The prism 3 is an integrated member composed of a plurality of members. The prism 3 is composed of four glass members including a first member 12, a second member 13, a third member 14 and a fourth member 15. Each glass member is obtained by attaching a wafer having a predetermined thickness and dicing the wafer into a prism shape. A reflective Littrow-type blaze diffraction grating 4 as a first optical: device is surface-machined on a plane 7 of the second member. A diffraction grating 18 is formed on a surface of the glass wafer using nano imprint or a gray scale fine machining method such as a gray scale mask or the like, and then is covered with a reflective film. When the laser beam reaches the blaze diffraction grating 4, a zero-order beam is reflected in a specular reflection direction, i.e., a path QR direction and a first-order diffracted beam is reflected in a direction opposite to the original path, i.e., a path QP direction. Instead, a zero-order beam and a m-order diffracted beam may be used. At any rate, the blaze diffraction grating 4 is of a Littrow type reflecting only two beams and is designed such that one of the two beams is reflected in the direction opposite to the original path. In the first embodiment, the blaze diffraction grating 4 uses BK7 having a refractive index of 1.53 as a material and has a blaze shape having a period of 0.187 μm and a depth of 0.26 μm. For a beam having an incident angle of 45°, the zero-order beam has efficiency of 2% in terms of a reflective angle of −45°, and the first-order beam has efficiency of 98% in terms of a reflective angle of 45°. Such a diffraction grating can be manufactured in large quantities by means of a mould by an ultra-fine machining using FIB or diamond and stamping by nano imrint. In addition, by making a blaze shape having a period of 0.562 μm and a depth of 0.64 μm using BK7, for a beam having an incident angle of 45°, it may be designed that the zero-order beam has efficiency of 2.7% in terms of a reflective angle of −45°, and a third-order beam has efficiency of 93% in terms of a reflective angle of 45°, Such a diffraction grating can be manufactured in large quantities by means of a gray scale mask or the like.

Here, the related techniques will be further described.

The prior techniques disclosed in Patent Document 1, Patent Document 2 and Non-Patent Document 1 have the following problems. Specifically, when the blaze diffraction grating is rotated, there occurs a so-called mode hop effect that a length of an external resonator is generally changed and the number of nodes of a stationary wave of a beam existing in the resonator is changed. This mode hop disturbs modulation of a continuous oscillation wavelength. The mode hop refers to a state where the number the stationary wave of the beam in the resonator is not fixed to one, but modes having two different nodes are mixed. In this state, since the beam loses autocorrelation and has deteriorated coherence, it is impossible to generate an interference fringe having high contrast in hologram recording and reproducing.

In the disclosed prior techniques, the mode hop is suppressed by synchronizing rotation of the blaze diffraction grating with adjustment of the length of the external resonator. However, although the rotation of the blaze diffraction grating and the adjustment of the length of the external resonator are not so problematic in manual use, they are not practical in a system requiring automatic adjustment in a recording apparatus. In addition, the disclosed prior techniques can not cope with a temperature change caused by laser heat generation. When temperature of a laser or an ambient temperature is changed, a length of a resonator in a diode chip and a length of the external resonator are changed accordingly and the number of nodes of a stationary wave is changed, which results in a mode hop. In addition, the disclosed prior techniques have problems in that the entire apparatus is still palm-sized and is not reduced to a size suitable for mass production, and costs per one apparatus is not still inexpensive for mass production.

In the prior technique disclosed in Non-Patent Document 2, a wavelength is tuned by adjusting a rotating angle and a position of a blaze diffraction grating in the same Littman type arrangement as the above example. In this prior technique, if an ambient temperature is constant, even when the blaze diffraction grating is rotated to tune the wavelength, the number of nodes of a stationary wave in an external resonator is always constant. However, in order to minimize a change of the length of the external resonator, which is caused by the change of the ambient temperature, a temperature sensor and a heater are provided to control the temperature, and stable oscillation is realized in a state where an apparatus is put in adiabatic circumstances. However, such a laboratory level measure is really no help at all for practical use as inexpensive products. In addition, since the Littman type can not simplify an optical path, this is not suitable for miniaturization of an apparatus.

The prior techniques disclosed in Patent Document 3, Patent Document 4 and Non-Patent Document 3 include an external resonator with Littrow arrangement, a blasé diffraction grating, a mode hop sensor composed of an optical wedge and a set of detectors, and a wavelength monitor composed of a prism and a set of detectors. An rotating angle of the blaze diffraction grating is adjusted to tune a wavelength, and these prior techniques are applied to hologram recording and reproducing apparatuses employing a wavelength division multiplexing system. The principal features of these prior techniques are that an optical system is simple with the Littrow arrangement and a mode hop due to a temperature change is solved by a mode lock by diode current adjustment. Since the position of the diffraction grating is not adjusted in tuning the wavelength, the length of the external resonator is changed with the rotation of the diffraction grating and thus the mode hop occurs essentially. This problem is avoided by not performing recording and reproducing operations when the wave length is tuned. However, the mode lock is required to be monitored even when the wavelength is tuned, and it is preferable that the mode hop does not essentially occur. In addition, these prior techniques have a configuration where a mode hop monitor is provided to express coherence numerically, and the mode hop caused by the change of the length of the resonator by the temperature change is suppressed by controlling the length of the resonator with Joule heat generated by diode current. However, these prior techniques have a problem of low reliability of measures to all error factors only with the current control of the diode laser. In addition, the disclosed prior techniques have a problem in that the entire apparatus is still about 50 square mm, although small as compared to other conventional apparatuses, and is not reduced to a size suitable for mass production. In addition, the disclosed prior techniques have a problem in that the mode hop sensor, the wave length and so on magnify and complicate the apparatus. In addition, the disclosed prior techniques have a problem in that an emission direction of the diode is opposite to a radiation direction of the laser beam and it is difficult to use the apparatus. In addition, the mode hop suppressing method of the disclosed prior techniques has a problem in that it can not be known if oscillation is made in which mode although the mode hop sensor can detect prevention of the mode hop after the current adjustment.

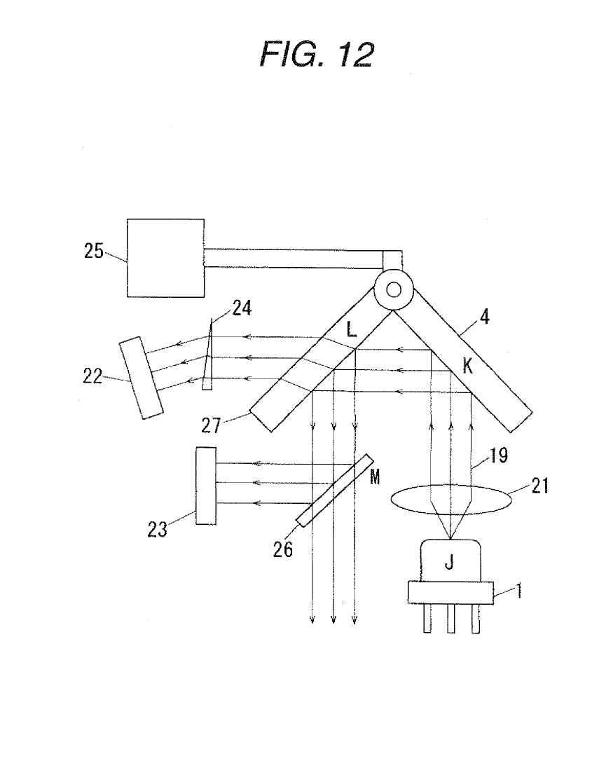

Here, in order to show how this embodiment solves the mode hop and realizes a stable single mode, the prior techniques disclosed in Patent Document 3, Patent Document 4 and Non-Patent Document 3 will be described with reference to FIG. 12 showing a conventional external cavity type laser light source device, and a structure of the mode hop will be described in detail based on this example. A laser beam of multi-mode oscillation is emitted at a predetermined divergent angle from the semiconductor laser 1. A semiconductor laser 1 essentially oscillates in a multi-mode. A collimator 21 converts the laser beam into a collimated beam 19. The collimated beam 19 is incident with a predetermined angle into a reflective blaze diffraction grating 4, a first-order beam (or designed m-order beam) is reflected to the opposite side with the same angle as the incident angle, and then the first-order beam returns to the semiconductor laser 1 through the collimator 21. The blaze diffraction grating is of a Littrow type, an incident angle θ_{In} is equal to a diffraction angle θ_{dif}, i.e., θ_{In}=θ_{dif}=θ, and the following relationship is satisfied.

2n_{EXT}p sin θ=mλ

Where, n_{EXT} is a refractive index of a medium of an external resonator. This first-order diffracted beam oscillates a path J-K as the external resonator. The blaze diffraction grating 4 has three roles. A first role is to make the external resonant path as mentioned above. A second role is to select a wavelength in the laser oscillating device. The external cavity type laser oscillator has a resonator of a laser source, an external resonator and at least two resonant paths. Oscillation to be finally output finally is produced when two oscillation wavelengths, that is, an oscillation wavelength λ_{LD} of the laser source and an oscillation wavelength λ_{EXT} of the external resonator, become equal to a wavelength λ_{G} selected by the blaze diffraction grating 4. This is the condition that the final external cavity type laser oscillator produces oscillation.

Although the blaze diffraction grating 4 is typically designed to reflect a first-order diffracted beam preferentially, it is designed such that diffraction efficiency of first-order diffraction is decreased in some degree on purpose in a case where it is used for the external resonator. This is for outputting a combination of a beam oscillated in the external resonant path and a zero-order beam out of the resonator That is, the blaze diffraction grating 4 performs a role of an output coupler as a third role. In this manner, the zero-order beam combined with the amplified beam passes through a path K-L and travels to a partial reflection mirror 27. Some of the zero-order beam is transmitted through the partial reflection mirror 27 and is incident into a wavelength detecting sensor 22 through an optical wedge 24. The optical wedge 24 converts the laser beam from an elliptical shape to a circular shape. The wavelength detecting sensor 22 is divided into two portions and performs a difference operation to know a relative position between the beam and the sensor This provides knowledge of angle of deviation of the beam and thus allows measurement of a setting angle of the blaze diffraction grating 4 and a selected wavelength band. In actuality, since the blaze diffraction grating 4 is rotated by a rotating mechanism such as a motor 25, it is ease to monitor the setting angle by measuring a pulse count of the motor 25. In addition, as described above, the first-order diffracted beam has a wavelength band and the wavelength detecting sensor 22 can not know which mode is selected in the wavelength band. The laser beam reflected by the partial reflection mirror 27 travels to a partial reflection mirror 26. Some of the laser beam is transmitted through the partial reflection mirror 26 and is incident into a mode hop sensor 23. The mode hop sensor 23 is composed of a plurality of division regions and determines coherence by measuring visibility, i.e., MTF (Modulation Transfer Function), of an interference fringe.

Hereinafter, determination of a mode and a structure of a mode hopping will be described. The oscillation wavelength λ_{LD} of the laser source, the oscillation wavelength λ_{EXT} of the external resonator, and the wavelength λ_{G} selected by the blaze diffraction grating have respective bands which will be described below, and a plurality of wavelengths at which oscillation conditions are satisfied exist discretely in a wavelength region in which the bands overlap with each other. This is the cause of the mode hop.

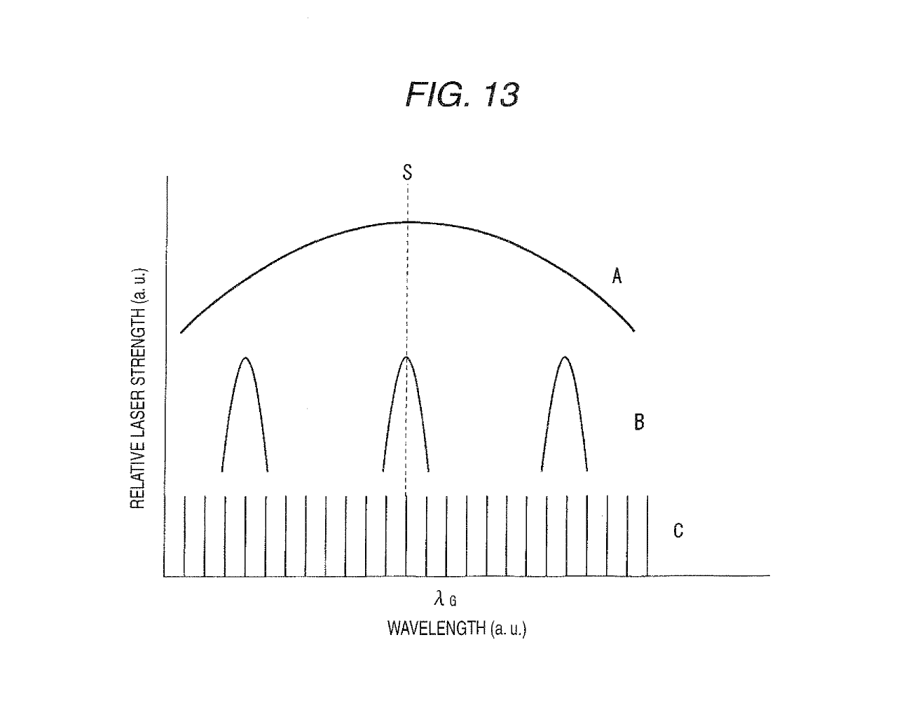

FIG. 13 illustrate an oscillation mode in a conventional external cavity type laser light source device, particularly showing features of an oscillation mode in the prior techniques disclosed in Patent document 3, Patent Document 4 and Non-Patent Document 3. A horizontal axis represents a wavelength and a vertical axis represents power of light. The vertical axis represents laser strength in any unit in respective curves, and relative magnitude between the curves has no meaning. The curves are drawn in a vertically deviated manner in order to make it ease to see the figure. A beam diffracted in the diffraction grating has a resolution defined by the following equation for a wavelength λ.

$${Δλ}_{G} = \frac{λ}{\vert m \vert Nw} \qquad [ Equation 2 ]$$

Where, |m|, N, and w are a diffraction order, the number of gratings per length, and a beam diameter (assumed as a circle), respectively. This width is a wavelength band of the diffracted beam. In these prior techniques, since a diffraction grating of a 3600 lines/mm, i.e., a period of 0.28 μm, is used for a 0.407 μm blue-violet laser, Δλ_{G}=113 pm (pm is 10⁻¹² m) under assumption of a first-order diffracted beam and a beam diameter of 1 mm. A curve A in FIG. 13 represents a wavelength band in a case where the blaze diffraction grating in the above specification is used.

On the other hand, oscillation conditions for the semiconductor laser are that there exists an integer k to satisfy the following equation for a refractive index n_{LD} in the resonator of the semiconductor laser and a predetermined length L_{LD} of the resonator.

$$k = \frac{2 {n}_{LD} {L}_{LD}}{λ} \qquad [ Equation 3 ]$$

The integer k represents the number of nodes of a stationary wave standing in the resonator. Such determination of the integer k means determination of an oscillation mode. Different wavelengths for the same resonator length L_{LD} may induce oscillation with the different number of nodes. A difference between a wavelength λₖ when oscillation is produced with the number of nodes of k and a wavelength λₖ₊₁ when oscillation is produced with the number of nodes of k+1 is called “mode interval,” which is defined as follows.

$${Δλ}_{LD} ≅ \frac{{λ}^{2}}{2 {n}_{LD} {L}_{LD}} \qquad [ Equation 4 ]$$

Assuming that a refractive index in a resonator of a blue laser is 3.3 and a resonator length is 0.6 mm, a mode interval Δλ_{LD} is 40 pm according to Patent Document 3. A wavelength band of one mode is about 10 pm, which is defined by a characteristic of the semiconductor laser. For example, this is defined by a band structure of GaInNf in a blue-violet laser. A curve B in FIG. 13 represents a plurality of oscillation modes of the semiconductor laser, each having a wavelength band of 10 pm.

Likely, oscillation conditions for the external resonator are that there exists an integer k_{EXT} to satisfy the following equation for an optical length L_{EXT} for a predetermined length of the external resonator.

$${k}_{EXT} = \frac{2 {L}_{EXT}}{λ} \qquad [ Equation 5 ]$$

A mode interval is defined as follows.

$${Δλ}_{EXT} ≅ \frac{{λ}^{2}}{2 {L}_{EXT}} \qquad [ Equation 6 ]$$

Assuming that n_{EXT} is 1 as medium is air and a resonator length is about 15 mm, a mode interval Δλ_{EXT} is 5 pm according to Patent Document 3. This is shown by C of FIG. 13. If the medium has no dispersion, the mode of the external resonator has little band as shown in the figure.

Taking notice to an inclusion relationship of curves corresponding to respective curves, final oscillation conditions can be understood. The final oscillation is produced when peaks at all wavelength bands substantially match each other. As a first characteristic, it can be seen from this figure that the number of modes to satisfy the oscillation conditions is not one since a wavelength band of the diffraction grating is larger than different wavelength bands. As a second characteristic, it can be seen that respective resonator modes (B and C) are discrete. From these two characteristics, it can be seen that there exist a plurality of allowable discrete modes. Transition of oscillation between the allowable discrete modes is called ‘mode hop.’ This is temporarily observed as average beams having a plurality of mode spectrums. If a mode hop occurs, since autocorrelation of the laser beam disappears and coherence is deteriorated, visibility of an interference fringe is deteriorated.

Since all peaks in a mode S at λ_{G} corresponding to a selected wavelength of the diffraction grating in the state as shown in FIG. 13 match each other, a mode is determined. If there is no disturbance in this state, the laser continues to oscillate in the determined mode permanently. However, if the peaks are deviated from each other due to any external factors, the determined mode may be transitioned to a different mode.

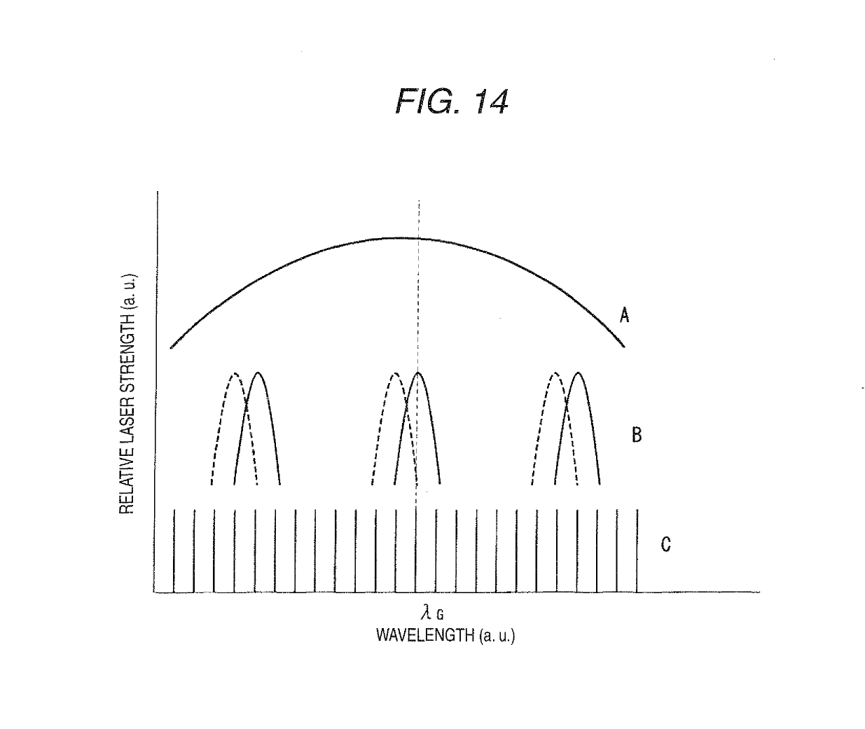

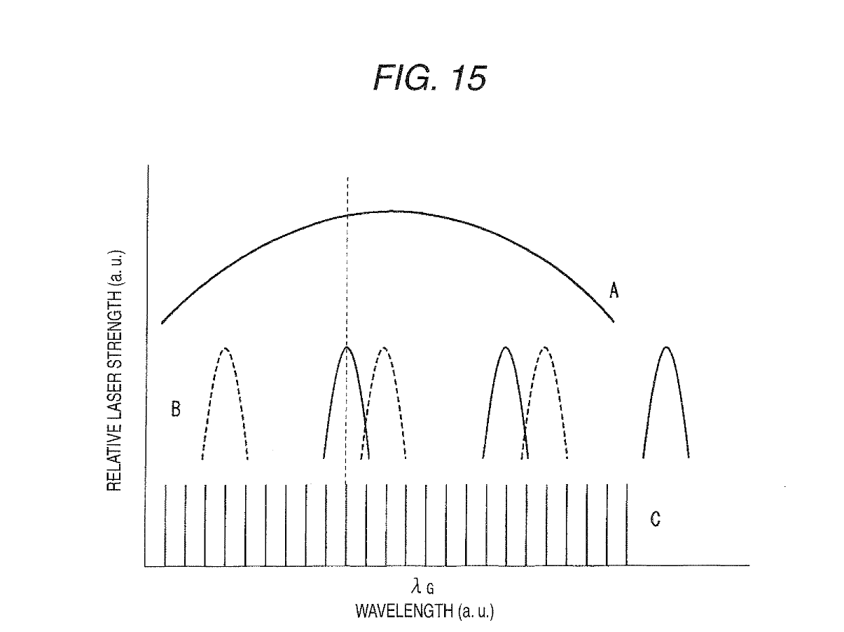

FIGS. 14 and 15 illustrate an oscillation mode in a conventional external cavity type laser light source device, showing a mode hop state when temperature of the semiconductor laser is changed and a length of the resonator in the semiconductor laser is changed (under assumption that a length of the external resonator is unchanged). When the resonator length of the semiconductor laser is continuously changed due to heat, a mode state continues to change an oscillation wavelength with the same number of nodes (state of k_{LD}) as expressed as follows.

$$\frac{{Δλ}_{LD}}{2} {k}_{LD} = {n}_{LD} Δ {L}_{LD} \qquad [ Expression 7 ]$$

However, since allowable mode are required to match the mode of the external resonator, the mode of the external resonator is hopped from k_{EXT} to k_{EXT}+1, k_{EXT}+2, . . . . This state is shown in FIG. 14. However, of the resonator length increases up to k_{EXT}+8, the mode of the semiconductor laser decreases from k_{LD} to k_{LD}−1. This is because a wavelength in the k_{LD}−1 mode is close to the maximum of the band of the diffraction grating. This is shown in FIG. 15. The mode of the external resonator naturally returns from k_{EXT}+7 to k_{EXT}. This is a mode hop of the semiconductor laser. In this manner, when the resonator length of the semiconductor laser is changed, the mode hop of the external resonator and the mode hop of the resonator of the semiconductor laser are repeated periodically.

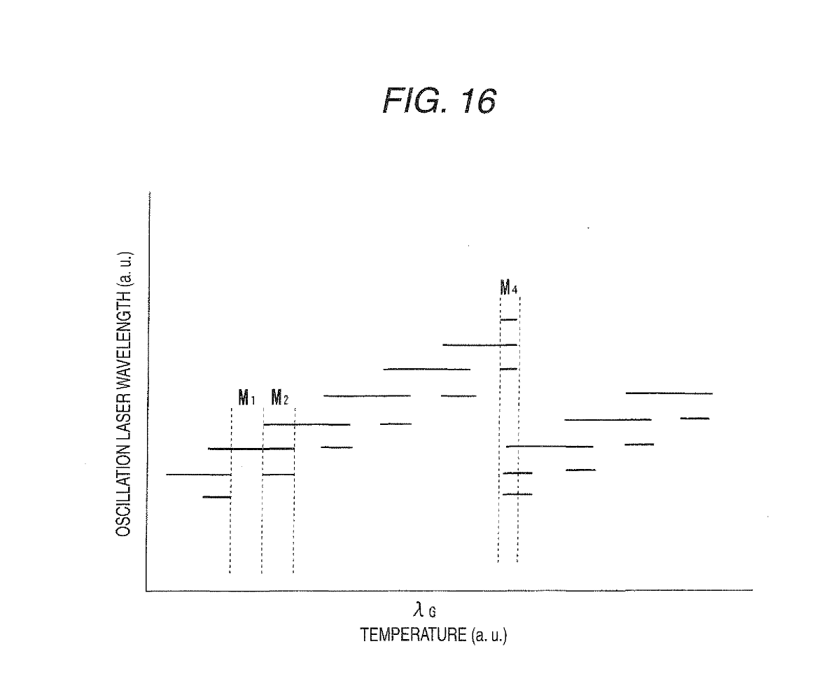

FIG. 16 illustrates an oscillation mode in a conventional external cavity type laser light source device, showing a relationship between temperature and oscillation wavelength when the resonator length of the semiconductor laser depends on temperature. As described above, in the figure, M₁ represents a single mode state, M₂ represents a multi-mode state taking two modes in the external resonator mode, and M₄ represents a multi-mode state in which all four modes including two modes in the semiconductor laser resonator mode and two modes in the external resonator mode are oscillated. The same mode hopping occurs in change of the external resonator length. When the temperature is changed, since the external resonator length is changed, the above takes place. However, in the above prior techniques, the external resonator length is changed whenever the blaze diffraction grating is rotated. Accordingly, when the blaze diffraction grating is rotated to tune a wavelength, a mode hop due to the external resonator necessarily occurs.

In the laser light source device according to this embodiment, as shown in FIG. 1, the first-order diffracted beam or m-order diffracted beam reflected from the blaze diffraction grating 4 is oscillated by the external resonator formed by a semiconductor laser emission point P and an irradiation point Q of the blaze diffraction grating 4. A distance PQ becomes an external resonator length. In the first embodiment, PQ is set to be 6 mm. In this case, a wavelength interval of the external resonator mode is 11.4 pm with an average refractive index of 1.2. In the first embodiment, a diagram of an oscillation mode is shown in FIG. 1l. Since a wavelength band WLD of a blue-violet semiconductor laser is about 10 to 15 pm as described with reference to FIG. 13, it generally satisfies Equation 8, which is the stable oscillation condition having no mode hop due to the external resonator. In this case, since only one external resonator mode exists in the wavelength band of the semiconductor laser 1, there occurs no mode hop of the external resonator with the change of the resonator of the semiconductor laser 1. This is the effect caused by decreasing the entire size by integrating functions into an integrated prism as in the first embodiment. In addition, in this embodiment, if necessary, the external resonator length can become less than 6 mm, which may result in further improvement of mode hop suppression effect. When the wavelength interval of the external resonator mode is adjusted, there occurs a trade-off between the mode hop suppression effect and a resolution of wavelength tuning. However, as long as very minute wavelength tuning is not be need, the mode hop suppression effect is advantageously preferential. This embodiment is particularly effective in the mode hop suppression. In a special case where the wavelength tuning is preferential, according to this embodiment, it is possible to reduce the wavelength interval in the external resonator mode by enlarging the external resonator length on purpose.

As described above, the blaze diffraction grating 4, is designed such that reflection of the zero-order beam exists by several %. The laser beam amplified in the external resonator is coupled with the zero-order beams and is outputted out of the resonator through the path QR. A plane 8 of the second member 13 is formed with a partial reflection mirror. 95% of the beam is specularly reflected and is emitted upward. In this manner, one of characteristics of this embodiment is that an incident angle of beam from the semiconductor laser source 1 is equal to an emission angle of the laser beam emitted from the prism. The laser beam emitted out of the prism from the point R is emitted, as a circular-polarized beam, out of the apparatus through a λ/4 plate 11.

In the plane 8, a fill refection film is formed on only the diffraction grating 18 while a partial reflection film is formed on the remaining portions. Some of the beam incident into the point R is transmitted and reaches a plane 9 of the third member 14 while the other component is reflected toward a recording medium. The plane 9 is a full reflector, and the beam reflected on a point S is reflected by the diffraction grating 18 as a fill reflector and reaches an beam detection means 6 through a path SW.

A wave front adjustment device 5, which is a portion of the second optical device and is a device providing a wave front aberration, is machined on the plane 9, and the diffraction grating 18, which is a portion of the second optical device, is formed on the plane 8 The transmitted beam given with the wave front aberration by the wave front adjustment device 5 is diffracted as three principal beams, for example, a zero-order beam and ± first-order diffracted beams in the diffraction grating 18. A grating period of the diffraction grating 18 is set to be a value at which the zero-order beam and the ± first-order diffracted beams partially overlap each other in the beam detection means 6. As a result, an interference shape depending on the kind of the wave front aberration is generated at the overlapping portion of the zero-order beam and the ± first-order diffracted beams on the beam detection means. This is the phenomenon that there occurs an interference fringe caused by an optical path difference between the zero-order beam and the ± first-order diffracted beams due to the wave front aberration, and is an application of a Ronchi test.

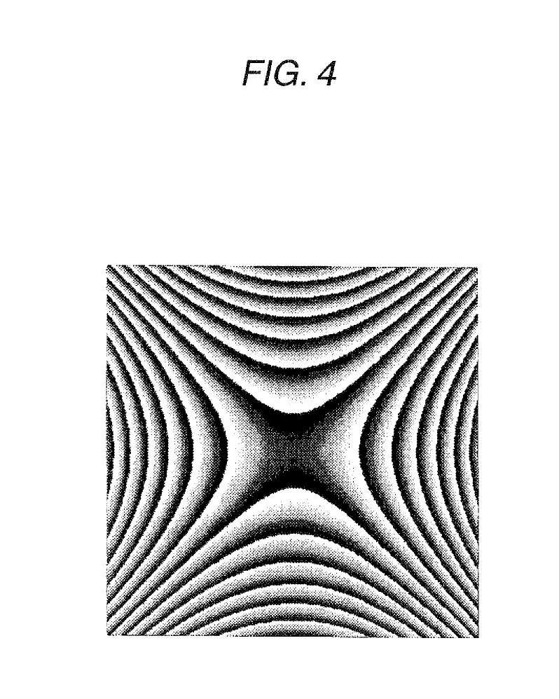

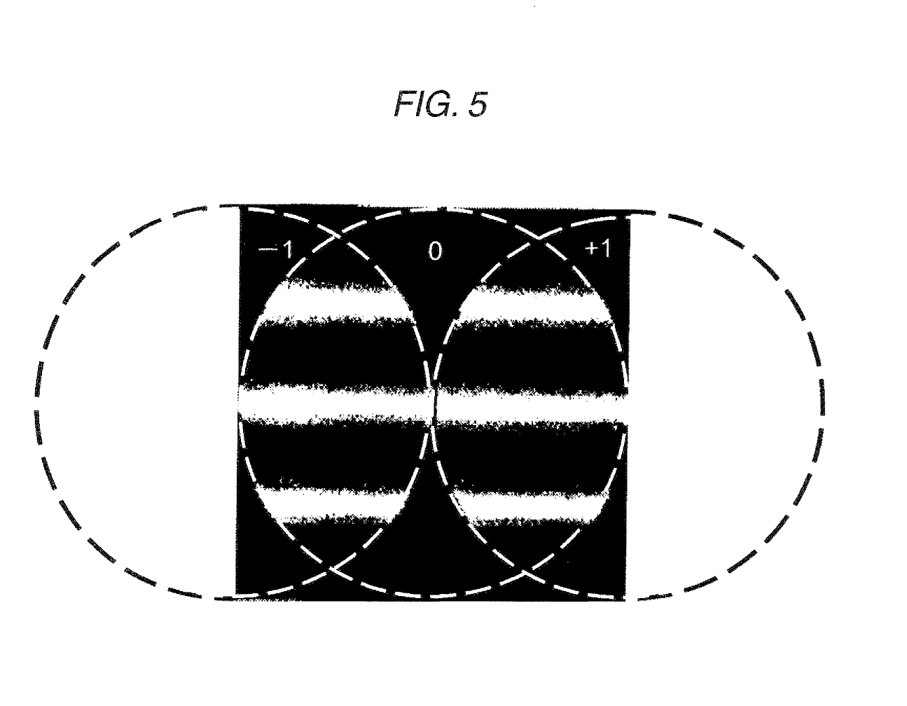

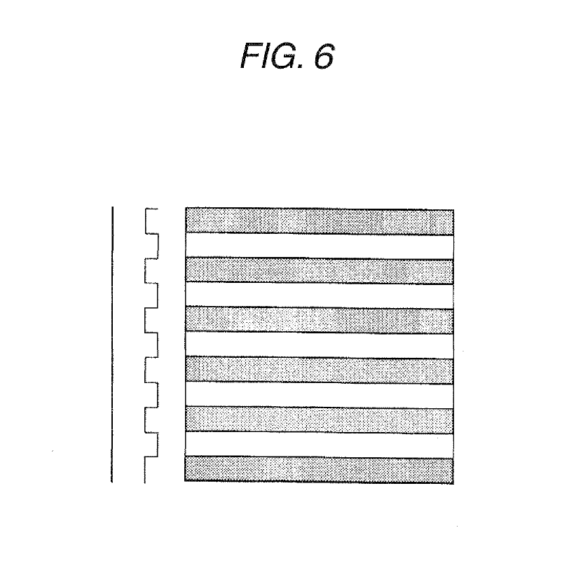

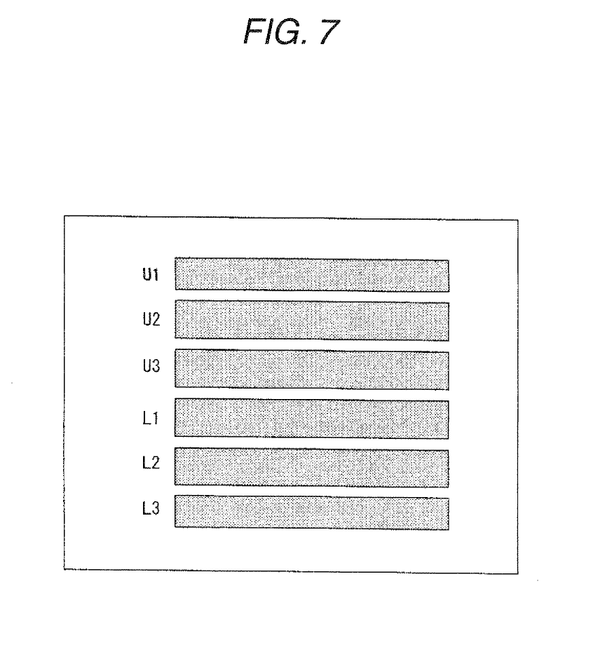

If an astigmatic Fresnel mirror as shown in FIG. 4 showing a contour line of an astigmatic Fresnel mirror according to the first embodiment is used as the wave front adjustment device 5 providing the wave front aberration, a plurality of linear interference fringes are obtained on the beam detection means 6 as shown in FIG. 5 showing an interference fringe pattern in the first embodiment. In this embodiment, a reflection curve surface of the wave front adjustment device 5 has preferably a shape such as a Fresnel mirror made thin according to a general Fresnel lens manufacturing process. A Fresnel mirror manufacturing method is suitable for mass production using a general gray scale mask. After machining the Fresnel mirror at the point S on a wafer having a predetermined thickness, the diffraction grating 18 is machined on the rear side of the same wafer with deviation by a predetermined interval. Since the diffraction grating 18 requires at least three diffracted beams, a binary diffraction grating as shown in FIG. 6 showing a diffraction grating pattern for laser beam split according to the first embodiment may be used. The above double-sided machining is possible by a semiconductor manufacturing method using an exposure such as a double-sided aligner or a stepper. After the double-sided machining, the diffraction grating 18 may be made by forming reflection film on both sides. In addition, the wave front aberration may be spherical focus or coma aberration. The beam detection means 6 is divided into a plurality of sensitivity regions as shown in FIG. 7 showing a detector pattern of the beam detection means according to the first embodiment, and the interference fringes formed as above overlap the plurality of sensitivity regions. This can be achieved by selecting a function type of the wave front adjustment device 5. In the first embodiment, the beam detection means is divided into, for example, six regions U1, U2, U3, L1, L2 and L3 and can detect visibility, i.e., MTF, of the interference fringe. The MTF is defined as follows.

$$MTF = \frac{{I}_{max} - {I}_{min}}{{I}_{max} + {I}_{min}} \qquad [ Equation 10 ]$$

Where, Iₘₐₓ and Iₘᵢₙ are the maximum value and the minimum value of a strength distribution of the interference fringe, respectively. These values can be calculated by an operation of signal voltages in the six regions. This allows measurement of coherence of the laser beam and monitor of coherence by real time measurement. If a mode hop occurs, since coherence is deteriorated and the MTF is also deteriorated, the existence of the mode hop can be detected. Accordingly, it is possible to suppress the mode hop in real time by controlling a posture of the prism based on a monitor value of the coherence. In addition, a position of an incident beam can be known by dividing the division regions into upper regions U1, U2 and U3 and lower regions L1, L2 and L3 and taking a difference signal. Accordingly, since a gradient of the blaze diffraction grating 4 can be known, a selected wavelength λ_{G} can be known. That is, an angle of the prism 3 can be known.

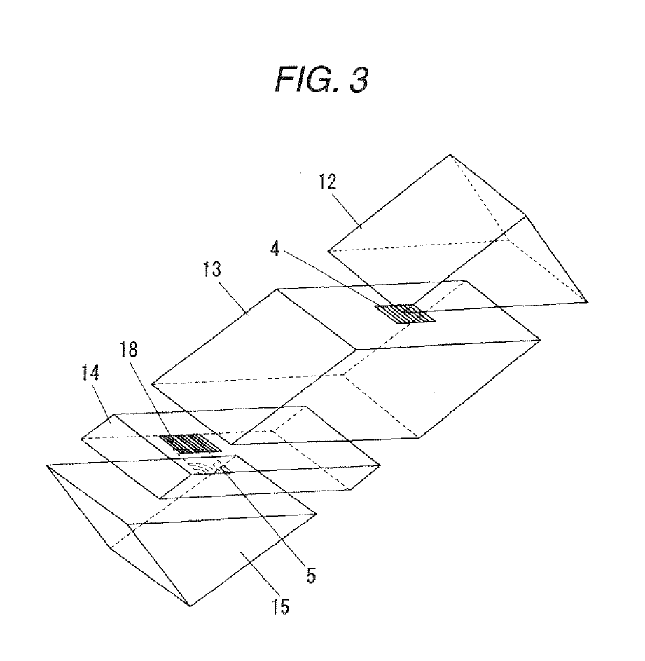

As described above, in the first embodiment, the Littrow type blaze diffraction grating and the Ronchi diagram generating device are integrated into a single member and have a very compact shape. A size of the prism is 6 mm in width, 6 mm in inner depth and 20 mm in length, and the prism can be manufactured with costs of 100 Yens or below per one prism. The prism 3 can be easily manufactured by integrating a plurality of transparent members using a laminating method and cutting an edge, as shown in FIG. 3 showing the prism according to the first embodiment. The blaze diffraction grating 4 is machined on the surface of the second member 13 and is covered by a reflection film. The wave front adjustment device 5 and the beam splitting device 18 are machined on respective surfaces of the third member 14 and are covered by a reflection film. In this manner, the optical device having plural functions is formed within the prism.

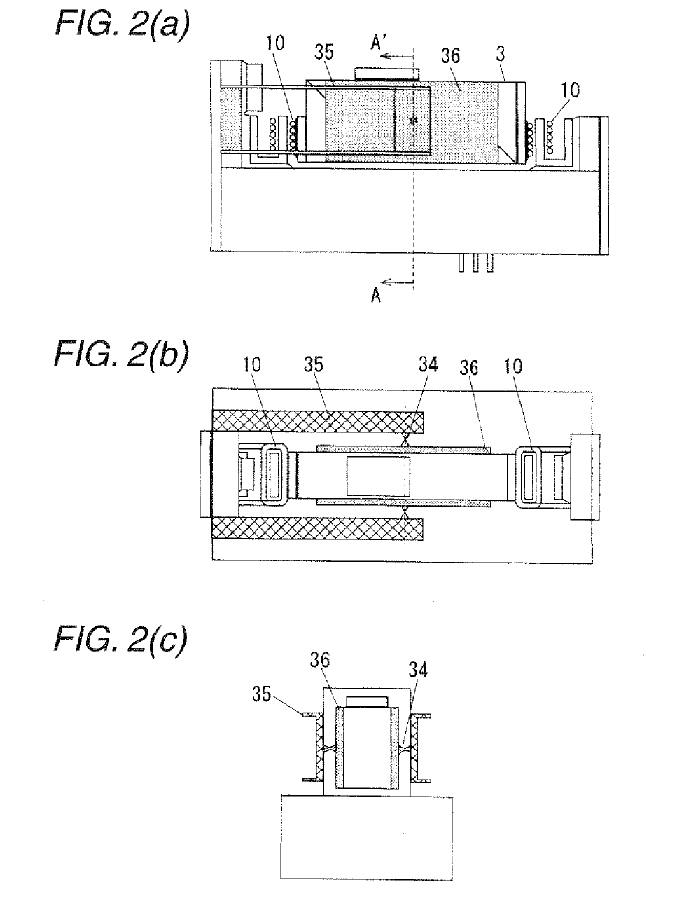

In the prism 3, coils 10 are fixed by adhesion to end sides of the first member 12 and the fourth member 15. The coils 10 constitute an electromagnetic actuator along with iron passing the coil core. The prism 3 is supported by a bearing 34 and a leaf spring 35 which are manufactured by molding and shaping, as shown in FIG. 2, and can be rotated and translated by current control of the electromagnetic actuator.

FIGS. 2(a) to 2(c) are views showing an external cavity laser light source device according to the first embodiment. FIG. 2(a) is a front view, FIG. 2(b) is a side view and FIG. 2(c) is a sectional view taken along a dotted line A-A′ in FIG. 2(b) when viewed from the right to the left. The bearing 34 may use, for example, a tension-shaped resin thin wire. The prism 3 is adhered closely to a support plate 36. The support plate 36 is combined with the leaf spring 35 through the bearing 34. The leaf spring 35 forms a four-point link and is translated approximate to the emission direction the laser beam. The rotation and translation of the prism 3 are made by controlling a voltage applied to the coils 10 arranged at both sides of the prism 3. The prism 3 can be rotated by applying different voltages to the left and right coils 10. The rotational direction can be changed by reversing a magnitude relationship of the different voltages. The translation can be made by applying the same voltage to the coils 10. The reverse translation can be made by reversing polarity of the voltage.

Although it is here illustrated that the electromagnetic actuator using an attractive force or a repulsive force by an electromagnetic force is used as a driving means for changing the position of the prism 3 which is the optical member, a piezoelectric device may be likely used as the driving means for changing the position of the optical member. For example, two piezoelectric devices are provided on a coupling member 31 to support both ends of the prism 3 shown in FIG. 1. Driving parts of the two piezoelectric devices are fixed by adhesion or the like to support the bottom of the second member 13 and the bottom of the fourth member 15, respectively. The rotation and translation of the prism 3 are made by controlling a voltage applied to the piezoelectric devices arranged in both sides of the prism 3. When the piezoelectric devices that drive the prism 3 by the same distance with the same voltage in the same direction are respectively arranged in both sides of the prism 3, the prism 3 can be rotated by applying different voltages to the piezoelectric devices. The rotational direction can be changed by reversing a magnitude relationship of the different voltages. The translation can be made by applying the same voltage to the piezoelectric devices. The reverse translation can be made by reversing polarity of the voltage. By using the piezoelectric devices as the driving means, it is possible to drive the prism 3 without using the coils 10, the bearing 34, the leaf spring 35 and the support plate 36 as described above with reference to FIGS. 2(a) to 2(c) and simplify the driving means.

The initial position of the prism 3 is determined by the beam detection means, and then, a rotation angel and a translation distance can be determined in real time. The leaf spring 35 may be made of resin or metal. A wavelength can be selected by rotating the prism 3 using the electromagnetic actuator. At this time, one characteristic of this embodiment is that the emission angle of the laser beam from the prism 3 is equal to the emission angle of the laser beam from the semiconductor laser 1 in the same direction even when the prism 3 is rotated. In addition, the length PQ of the external resonator is changed with the rotation of the prism 3 and a mode hop of an external resonant mode generally occurs.

However, according to this embodiment, since the prism 3 is translated at the same time of rotation such that the external resonator length remains constant, the mode hop can be avoided. In addition, a liquid crystal device may be included in the third optical device 2. By electrically controlling a refractive index in the external resonator path using the liquid crystal device, it is possible to adjust an optical distance for the external resonator length. Accordingly, by selecting a wavelength with the rotation of the blaze diffraction grating 4 and controlling a voltage applied to the liquid crystal device, it is possible to adjust oscillation conditions.

The device according to this embodiment is characterized in that the blaze diffraction grating 4, the wave front adjustment device 5, and the diffraction grating 18 that splits the beam are integrated into a single member, and the semiconductor laser 1, the beam shaping device, the collimator, the electromagnetic actuator and a temperature compensation means 30 are integrated by the coupling member 31. The temperature compensation means 30 may be arranged around a package of the semiconductor laser 1 or the coupling member 31. The temperature can be controlled by using a thermal-electric converting device such as a Peltier device as the temperature compensation means. Accordingly the resonator length can remain constant, thereby alleviating a mode hop caused by change of temperature. Conversely, by actively changing the resonator length by controlling the temperature, it is possible to suppress a mode hop caused by other factors.

### Second Embodiment

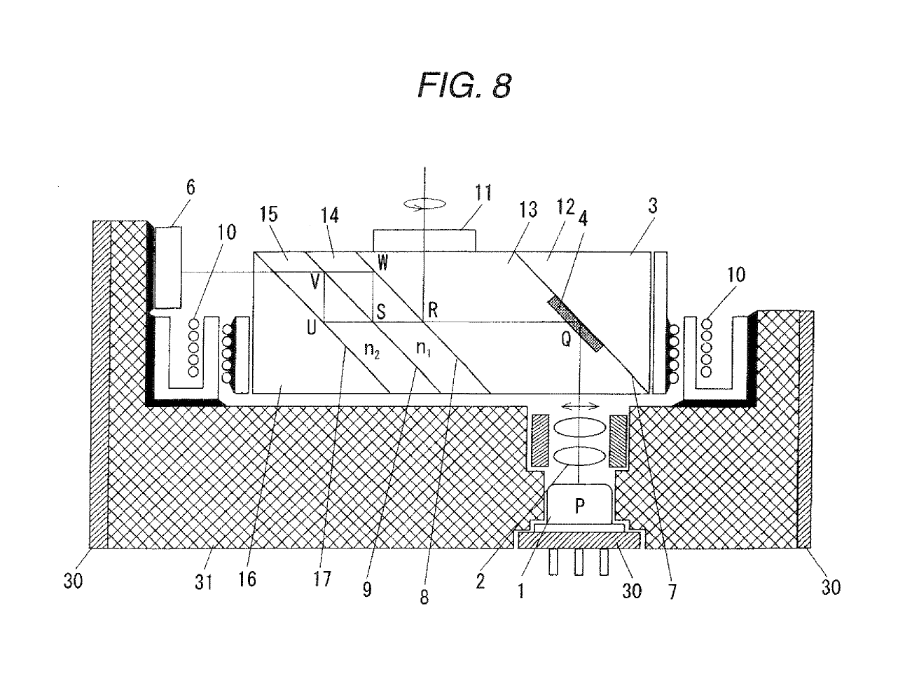

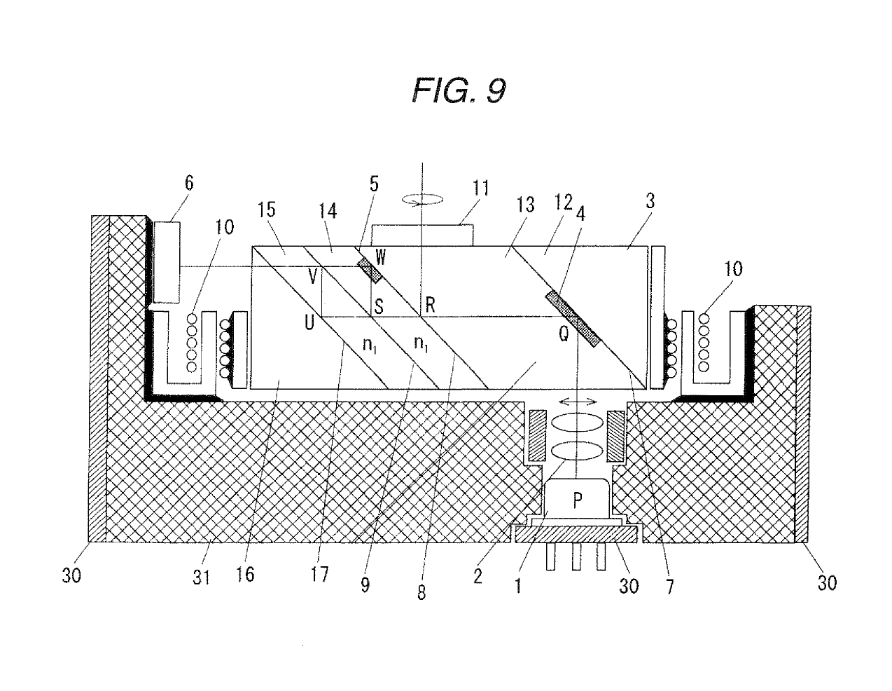

A laser light source device according to a second embodiment will be described with reference to FIGS. 8 and 9 showing an external cavity type laser light source device according to a second embodiment. A laser used herein is an available semiconductor laser with a wavelength of 405 nm and power of 150 mW. The semiconductor laser has a resonator of length of 600 μm and outputs a linearly-polarized laser beam having a horizontal divergence half-value angle of 9° and a vertical divergence half-value angle of 21°. A multi-mode laser beam emitted with a predetermined divergent angle from a semiconductor laser 1 is incident into a third optical device 2. The third optical device 2 is composed of, for example, an optical device for collimating a divergent beam into a parallel beam and an optical device for converting an elliptical laser bean into a circular laser beam. The laser beam passed through the third optical device 2 is incident into a prism 3. The prism 3 is composed of five glass members including a first member 12, a second member 13, a third member 14, a fourth member 15 and a fifth member 16. Each glass member is obtained by attaching a wafer having a predetermined thickness and dicing the wafer into a prism shape. A reflective Littrow-type blaze diffraction grating 4 as a second optical device is surface-machined on a plane 7 of the second member. When the laser beam reaches the blaze diffraction grating 4, a zero-order beam is reflected in a specular reflection direction, i.e., a path QR direction and a first-order diffracted beam is reflected in a direction opposite to the original path, i.e., a path QP direction. The first-order diffracted beam reflected from the blaze diffraction grating 4 is oscillated by the external resonator formed by a semiconductor laser emission point P and an irradiation point Q of the blaze diffraction grating 4. The laser beam amplified in the external resonator is coupled with the zero-order beam and is outputted out of the resonator through the path QR. A plane 8 of the second member 13 is formed with a partial reflection mirror at a point R and formed with a fill reflection mirror at a point W. Most of the beam is specularly reflected at the point R and is emitted upward, as a circular-polarized beam, out of the apparatus through a λ/4 plate 11, while the remainder of the beam is transmitted and reaches a plane 9 of the third member 14. The plane 9 is coated with a half mirror. A plane 17 is formed with a fill reflection film at a point U and is transparent at other portions. The beam reflected at a point S passes through a path S-W-V while the beam transmitted at the point S passes through a path S-U-V and reaches the beam detection means 6. The path S-W-V and the path S-U-V form a Mach-Zehnder interferometer. Materials having different refractive indexes n₁ and n₂ are selected for the third member 14 and the fourth member 15, respectively. Accordingly, a uniform phase difference is caused on the entire plane of the laser beam at an optical distance of the respective paths, thereby producing an interference fringe in the beam detection means 6. The beam detection means is divided into, for example, six regions U1, U2, U3, L1, L2 and L3 and can detect MTF of the interference fringe.

As described above, in the second embodiment, the Littrow type blaze diffraction grating and the Mach-Zehnder interferometer are integrated into a single member and have a very compact shape. A size of the prism is 6 mm in width, 6 mm in inner depth and 20 mm in length, and the prism can be manufactured with costs of 100 Yens or below per one prism. Mode hop detection, wavelength detection, driving mechanism and so on are the same as the first embodiment.

Another means for giving the phase difference is shown in FIG. 9. In this figure, materials having the same refractive index n₁ are selected for the third member 14 and the fourth member 15. A wave front adjustment device 5 providing a wave front aberration is machined on the surface of the third member 14. With this configuration, only the beam passed through the path SW is provided with the wave front aberration, thereby causing an ununiform phase difference and hence producing an interference fringe in the beam detection means 6.

### Third Embodiment

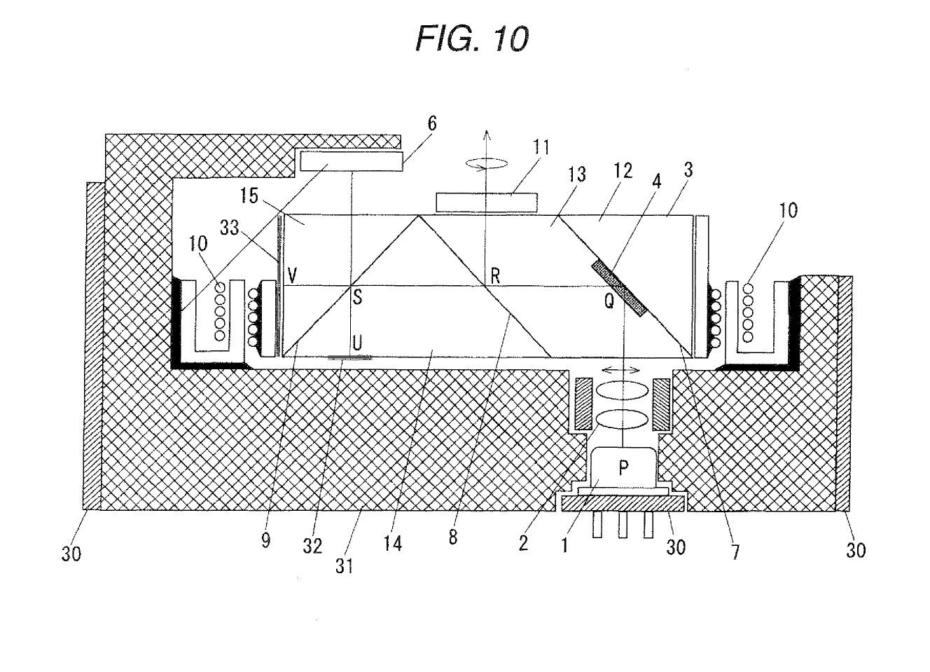

A laser light source device according to a third embodiment will be described with reference to FIG. 10 showing an external cavity type laser light source device according to a third embodiment. A laser used herein is an available semiconductor laser with a wavelength of 405 nm and power of 150 mW. The semiconductor laser has a resonator of length of 600 μm and outputs a linearly-polarized laser beam having a horizontal divergence half-value angle of 9° and a vertical divergence half-value angle of 21°. A multi-mode laser beam emitted with a predetermined divergent angle from a semiconductor laser 1 is incident into a third optical device 2. The third optical device 2 is composed of, for example, an optical device for collimating a divergent beam into a parallel beam and an optical device for converting an elliptical laser bean into a circular laser beam. The laser beam passed through the third optical device 2 is incident into a prism 3. The prism 3 is composed of four glass members including a first member 12, a second member 13, a third member 14 and a fourth member 15. Each glass member is obtained by attaching a wafer having a predetermined thickness and dicing the wafer into a prism shape. A reflective Littrow-type blaze diffraction grating 4 as a second optical device is surface-machined on a plane 7 of the second member. When the laser beam reaches the blaze diffraction grating 4, a zero-order beam is reflected in a specular reflection direction, i.e., a path QR direction and a first-order diffracted beam is reflected in a direction opposite to the original path, i.e., a path QP direction. The first-order diffracted beam reflected from the blaze diffraction grating 4 is oscillated by the external resonator formed by a semiconductor laser emission point P and an irradiation point Q of the blaze diffraction grating 4. The laser beam amplified in the external resonator is coupled with the zero-order beam and is outputted out of the resonator through the path QR. A plane 8 of the second member 13 is formed with a partial reflection mirror. Most of the beam is specularly reflected at a point R and is emitted upward, as a circular-polarized beam, out of the apparatus through a λ/4 plate 11. Some of the beam incident into the point R is transmitted and reaches a third plane 9 of the third member 14. The third plane 9 is coated with a half mirror. The bottom 32 of the third member 14 and an end side 33 of the fourth member 15 are a till reflector, and beams branched at the point S reach the beam detection means 6 through a path S-U and a path S-V, respectively The path S-U and the path S-V form a Michelson interferometer. Materials having different refractive indexes are properly selected for the third member 14 and the fourth member 15, respectively. Accordingly, a difference in optical distance between respective paths occurs, thereby producing an interference fringe in the beam detection means 6. The beam detection means is divided into, for example, six regions U1, U2, U3, L1. L2 and L3 and can detect MTF of the interference fringe.

As described above, in the second embodiment, the Littrow type blaze diffraction grating and the Michelson interferometer are integrated into a single member and have a very compact shape. A size of the prism is 6 mm in width, 6 mm in inner depth and 20 mm in length, and the prism can be manufactured with costs of 100 Yens or below per one prism. Mode hop detection, wavelength detection, driving mechanism and so on are the same as the first embodiment.

As described in the above first, second and third embodiments, the laser light source device according to these embodiments includes:

(1) a laser light source that emits a laser beam, a first optical device that returns some of a beam emitted from the laser light source so as to induce oscillation at a particular wavelength between some of the beam and the laser light source so that the beam emitted from the laser light source becomes close to a single wavelength, and reflects other portion of the emitted beam, a second optical device that forms an interference fringe from a reflected beam from the first optical device, a beam detection unit that detect a main wavelength of a plurality of wavelengths included in a beam derived from the second optical device and detects an ununiform state of the plurality of wavelengths, a partial reflection mirror that transmits some of the reflected beam from the first optical device to the second optical device and reflects the other portion of the reflected beam toward a recording medium, an optical member that integrally includes the first optical device, the second optical device and the partial reflection mirror, and a driving unit that changes a position of the optical member. With this configuration, while maintaining the function of the first optical device for causing the oscillation at the particular wavelength between some of the emitted beam and the laser light source so that a wavelength of the beam emitted from the laser light source becomes close to a single wavelength by configuring an integrated optical member by interposing the partial reflection mirror, which transmits some of the reflected beam from the first optical device to the second optical device and reflects the other portion of the reflected beam toward the recording medium, between the first optical device and the second optical device, it is possible to realize miniaturization of the laser light source device without injuring a special function required for hologram recording by arranging the beam detection unit, which detects the main wavelength of the plurality of wavelengths included in the beam derived from the second optical device and detects the ununiform state of the plurality of wavelengths, in the outside of the optical member and extracting the reflected beam toward which the recording medium is reflected between the first optical device and the second optical device. In addition, by integrating the first optical device, the second optical device and the partial reflection mirror, which are main parts, in the single member, it is possible to reduce ununiformity of relative position between the optical devices and miniaturize the laser light source device with high precision and low costs.

Accordingly, it is possible to obtain laser beam oscillation of a single mode with no mode hop, thereby providing a wavelength-tunable laser light source device which is miniaturized suitable for mass production, low in costs and high in precision.

(2) Preferably, a plane of the first optical device that reflects the emitted beam from the laser light source is in parallel to a plane of the partial reflection mirror that reflects some of the reflected beam from the first optical device toward the recording medium. With this configuration, it is possible to use a laminate method of overlapping and adhering wafers to manufacture the optical member, thereby manufacturing the laser light source device with very low costs.

(3) Preferably, the second optical device has at least two reflection planes, and a plane of the first optical device that reflects the emitted beam from the laser light source, a plane of the partial reflection mirror that reflects some of the reflected beam from the first optical device toward the recording medium, and at least two planes of the second optical device are parallel to each other. With this configuration, it is possible to use a laminate method of overlapping and adhering wafers to manufacture the optical member, thereby manufacturing the laser light source device at very low costs.

(4) Preferably, the optical member is made of glass. With this configuration, it is possible to improve tolerance of the optical member to a blue or violet laser, thereby allowing use of a short wavelength in high density recording.

(5) Preferably, the first optical device is a blaze diffraction grating with Littrow arrangement. With this configuration, it is possible to make the optical member in the form of a prism, thereby simplifying an optical path and reducing the size of the laser light source device.

(6) Preferably, the second optical device divides an incident beam from the partial reflection mirror into at least two beams and changes optical distances in respective paths of the two beams. With this configuration, it is possible to obtain an interference pattern occurring due to a uniform phase difference over the entire plane of a beam diameter in the laser beam generated in the laser light source device, thereby allowing measurement of coherence.

(7) Preferably, the second optical device divides an incident beam from the partial reflection mirror into at least two beams and provides at least one of the two beams with a wave front aberration different from a wave front aberration of the other of the two beams. With this configuration, it is possible to obtain an interference pattern occurring due to a phase difference distribution in a beam diameter with a simple configuration in the laser beam generated in the laser light source device, thereby allowing measurement of coherence.

(8) Preferably, the second optical device includes a device that provides a wave front aberration to the beam transmitted through the partial reflection mirror and a diffraction grating that divides the beam transmitted through the partial reflection mirror into at least two beams. With this configuration, it is possible to obtain an interference pattern occurring due to a phase difference distribution in a beam diameter with a simple configuration in the laser beam generated in the laser light source device, thereby allowing measurement of coherence. In addition, it is possible to set the interference pattern randomly by pre-designing an aberration of the device that provides the wave front aberration, thereby facilitating alignment with arrangement of a sensor pattern in the beam detection unit.

(9) Preferably, the second optical device includes a series of optical devices constituting a symmetrical or asymmetrical Mach-Zehnder interference optical system. With this configuration, it is possible to obtain an interference pattern easily, thereby allowing measurement of coherence. In addition, it is possible to easily realize the Mach-Zehnder interference optical system using the optical member manufactured by a laminate method to laminate and machining wafers simply, thereby manufacturing the laser light source device at very low costs.

(10) Preferably, the second optical device includes a series of optical devices constituting a symmetrical or asymmetrical Mach-Zehnder interference optical system having at least two transparent members having different refractive indexes. With this configuration, it is possible to obtain an interference pattern occurring due to a uniform phase difference over the entire plane of a beam diameter in the laser beam generated in the laser light source device, thereby allowing measurement of coherence. In addition, it is possible to produce interference pattern in a predetermined direction by laminating used materials with their refractive indexes changed, thereby facilitating alignment with arrangement of a sensor pattern in the beam detection unit.

(11) Preferably, the second optical device includes a series of optical devices constituting a symmetrical or asymmetrical Mach-Zehnder interference optical system having two interference paths and a member that provides a wave front aberration to one of the two interference paths. With this configuration, it is possible to obtain an interference pattern occurring due to a phase difference distribution in a beam diameter in the laser beam generated in the laser light source device, thereby allowing measurement of coherence. In addition, it is possible to set the interference pattern randomly by pre-designing an aberration of the device that provides the wave front aberration, thereby facilitating alignment with arrangement of a sensor pattern in the beam detection unit.

(12) Preferably, the second optical device includes a series of optical devices constituting a Michelson interference optical system. With this configuration, it is possible to obtain an interference pattern easily, thereby allowing measurement of coherence. In addition, it is possible to easily realize the Michelson interference optical system using the integrated optical member manufactured by a laminate method to laminate and machining wafers simply, thereby manufacturing the laser light source device at very low costs.

(13) Preferably, the second optical device includes a series of optical devices constituting a Michelson interference optical system having at least two transparent members having different refractive indexes. With this configuration, it is possible to obtain an interference pattern occurring due to a uniform phase difference over the entire plane of a beam diameter in the laser beam generated in the laser light source device, thereby allowing measurement of coherence. In addition, it is possible to produce interference pattern in a predetermined direction by laminating used materials with their refractive indexes changed, thereby facilitating alignment with arrangement of a sensor pattern in the beam detection unit.

(14) Preferably, the second optical device includes a series of optical devices constituting a Michelson interference optical system having two interference paths and a member that provides a wave front aberration to one of the two interference paths. With this configuration, it is possible to set the interference pattern randomly by pre-designing an aberration of the member that provides the wave front aberration, thereby facilitating alignment with arrangement of a sensor pattern in the beam detection unit.

(15) Preferably, the driving unit rotates the optical member so that an angle formed by an optical axis of the laser beam directing from the laser light source to the first optical device and a plane of the first optical device is varied. With this configuration, since an angle of the blaze diffraction grating in the first optical device with respect to the optical axis of the laser beam emitted from the laser light beam can be varied, a diffracted beam having a different wavelength to satisfy a diffraction grating equation (Equation 1) can return to and oscillate the laser light source, thereby providing a single mode laser light source having any wavelength in a range of rotation angle.

(16) Preferably, the driving unit oscillates a particular wavelength between the laser light source and the second optical device by rotating the optical member around a predetermined rotation axis and translating an optical axis of the incident beam directing from the laser light source to the first optical device. With this configuration, by rotating and translating the optical member at once for mode tracking, it is possible to adjust a length of a resonator to satisfy resonant conditions of an external resonator for a selected wavelength, thereby providing a simple wavelength-tunable single mode laser.

(17) Preferably, the laser light source device further includes a third optical device that shapes the laser beam emitted from the laser light source and an electro-optic device that is interposed between the third optical device and the first optical device and adjusts an optical distance with respect to an external resonator length formed by the laser light source and the first optical source. With this configuration, since the optical distance of the external resonator can be electrically adjusted without translating the blaze diffraction grating, it is possible to adjust the external resonator length changed when the blaze diffraction grating is rotated, so that a selected wavelength satisfies oscillation conditions.

(18) Preferably, the laser light source device farther includes a third optical device that shapes the laser beam emitted from the laser light source and a liquid crystal device that is interposed between the third optical device and the first optical device and adjusts an optical distance with respect to an external resonator length formed by the laser light source and the first optical source. With this configuration, by using liquid crystal for a device that adjusts the optical distance with respect to the external resonator length, it is possible to electrically adjust the optical distance of the external resonator without translating the blaze diffraction grating, thereby making it possible to adjust the external resonator length changed when the blaze diffraction grating is rotated, so that a selected wavelength satisfies oscillation conditions.

(19) Preferably, the driving unit uses an electromagnetic actuator using an attractive force or a repulsive force by an electromagnetic force. By using the electromagnetic force for the driving unit, it is possible to obtain a rotating mechanism without any abrasion by a non-contact force and at low costs.

(20) Preferably, the laser light source is a semiconductor laser. Since the semiconductor laser is an inexpensive multi-mode light source and has a variety of wavelengths, it is possible to realize mass production.

(21) Preferably, assuming that an optical distance of an external resonator length is L_{EXT}, a wavelength band of a semiconductor laser is W_{LD} and a wavelength of a laser beam is λ, L_{EXT} falls within a range to satisfy the following equation for W_{LD}.

$${L}_{EXT} \leq \frac{{λ}^{2}}{2 {W}_{LD}} \qquad [ Equation 8 ]$$

A mode interval of the external resonator is expressed by the following Equation 9 from Equation 6.

$${Δλ}_{EXT} ≅ \frac{{λ}^{2}}{2 {L}_{EXT}} \qquad [ Equation 9 ]$$

Accordingly, when Equation 8 is satisfied, the mode interval of the external resonator becomes larger than the wavelength band W_{LD} of the semiconductor laser. With this configuration, since the mode interval of the external resonator can become equal to or larger than the wavelength of the semiconductor laser, it is possible to suppress a minute mode hop due to the external resonator. In a system that does not require a large interval of wavelength tuning, it is possible to provide a stable configuration without need to widen a wavelength interval of a mode by the external resonator.

(22) Preferably the third optical device according to (17) or (18) has a beam shaping function of shaping a beam incident from the laser light source into a circular beam and a collimation function of collimating a beam incident from the laser light source into a parallel beam. Since collimation and beam shaping are performed at once, it is possible to reduce the number of optical parts, thereby reducing a device size and costs.

(23) Preferably, the third optical device according to (17) or (18) has a beam shaping function of shaping a beam incident from the laser light source into a beam having a flat top strength distribution and a collimation function of collimating a beam incident from the laser light source into a parallel beam. By providing the flat top strength distribution, an intensity distribution of an interference fringe for hologram recording becomes uniform, thereby making it possible to significantly increase efficiency of multi-recording as compared to a Gaussian strength distribution.

(24) Preferably, the laser light source device further includes a temperature compensation unit that compensates for a resonator length changed depending on change of ambient temperature of a resonator of the laser light source or an external resonator formed by the laser light source and the first optical device. With this configuration, the resonator length changed depending on change of ambient temperature of the resonator of the laser light source or the external resonator can be compensated for, thereby making it possible to keep the resonator length constant and hence suppress a mode hop.

(25) Preferably, the laser light source device further includes a λ/4 wavelength plate that intercepts a beam entering from the outside of the optical member, and the λ/4 wavelength plate is interposed between the partial reflection mirror and the recording medium and is provided to contact a wall of the optical member. With this configuration, an unnecessary reflected beam returns to the external resonator, thereby avoiding disturbance of oscillation.

(26) Preferably, the beam detection unit is divided into a plurality of electrically-isolated regions. With this configuration, it is possible to measure a pattern of a beam irradiated on the beam detection unit, thereby making it possible to monitor a state of beam.

(27) Preferably, the beam detection unit calculates a Modulation Transfer Function by calculating contrast of a pattern of a received beam from signals detected in the plurality of regions. With this configuration, it is possible to calculating the Modulation Transfer Function of the laser beam, thereby making it possible to monitor coherence of the laser beam.

(28) Preferably, the beam detection unit learns a history of a sum signal detected in the plurality of regions. With this configuration, an actual oscillation wavelength can be known.

This application is based upon and claims the benefit of priority of Japanese Patent Application No. 2007-017923 filed on Jan. 29, 2007, the contents of which are incorporated herein by reference in its entirety.

1. A laser light source device comprising:
a laser light source;
a first optical device that returns a portion of an emitted beam, emitted from the laser light source, so that the beam emitted from the laser light source becomes close to a single wavelength, and reflects other portion of the emitted beam;
a second optical device that forms an interference fringe from a reflected beam from the first optical device;
a beam detection unit that detects a main wavelength of a plurality of wavelengths included in a beam derived from the second optical device and detects a distribution of the plurality of wavelengths;
a partial reflection mirror that transmits some of the reflected beam from the first optical device to the second optical device and reflects the other portion of the reflected beam toward a recording medium;
an optical member that integrally includes the first optical device, the second optical device and the partial reflection mirror; and
a driving unit that changes a position of the optical member.

2. The laser light source device according to claim 1, wherein a plane of the first optical device that reflects the emitted beam from the laser light source is in parallel to a plane of the partial reflection mirror that reflects some of the reflected beam from the first optical device toward the recording medium.

3. The laser light source device according to claim 1, wherein the second optical device has at least two reflection planes, and a plane of the first optical device that reflects the emitted beam from the laser light source, a plane of the partial reflection mirror that reflects some of the reflected beam from the first optical device toward the recording medium, and at least two planes of the second optical device are parallel to each other.

4. The laser light source device according to claim 1, wherein the second optical device divides an incident beam from the partial reflection mirror into at least two beams and changes optical distances in respective paths of the two beams.

5. The laser light source device according to claim 1, wherein the second optical device divides an incident beam from the partial reflection mirror into at least two beams and provides at least one of the two beams with a wavefront aberration that is different from a wavefront aberration of the other of the two beams.

6. The laser light source device according to claim 1, wherein the second optical device includes a device that provides a wave front aberration to the beam transmitted through the partial reflection mirror and a diffraction grating that divides the beam transmitted through the partial reflection mirror into at least two beams.

7. The laser light source device according to claim 1, wherein the second optical device includes a series of optical devices constituting a symmetrical or asymmetrical Mach-Zehnder interference optical system.

8. The laser light source device according to claim 1, wherein the second optical device includes a series of optical devices constituting a symmetrical or asymmetrical Mach-Zehnder interference optical system having at least two transparent members having different refractive indexes.

9. The laser light source device according to claim 1, wherein the second optical device includes a series of optical devices constituting a symmetrical or asymmetrical Mach-Zehnder interference optical system having two interference paths and a member that provides a wave front aberration to one of the two interference paths.

10. The laser light source device according to claim 1, wherein the second optical device includes a series of optical devices constituting a Michelson interference optical system.

11. The laser light source device according to claim 1, wherein the second optical device includes a series of optical devices constituting a Michelson interference optical system having at least two transparent members having different refractive indexes.

12. The laser light source device according to claim 1, wherein the second optical device includes a series of optical devices constituting a Michelson interference optical system having two interference paths and a member that provides a wave front aberration to one of the two interference paths.

13. The laser light source device according to claim 1, wherein the driving unit rotates the optical member so that an angle formed between an optical axis of the laser beam directing from the laser light source to the first optical device and a plane of the first optical device is varied.

14. The laser light source device according to claim 1, wherein the driving unit oscillates a particular wavelength between the laser light source and the second optical device by rotating the optical member around a predetermined rotation axis and translating an optical axis of the incident beam directing from the laser light source to the first optical device.

15. The laser light source device according to claim 1, wherein the laser light source device further includes:
a third optical device that shapes the laser beam emitted from the laser light source; and
an electro-optic device that is interposed between the third optical device and the first optical device and adjusts an optical distance with respect to an external resonator length formed by the laser light source and the first optical source.

16. The laser light source device according to claim 1, wherein the laser light source device farther includes:
a third optical device that shapes the laser beam emitted from the laser light source; and
a liquid crystal device that is interposed between the third optical device and the first optical device and adjusts an optical distance with respect to an external resonator length formed by the laser light source and the first optical source.

17. The laser light source device according to claim 1, wherein, assuming that an optical distance of an external resonator length is L_{EXT}, a wavelength band of a semiconductor laser is W_{LD} and a wavelength of a laser beam is λ, L_{EXT} falls within a range to satisfy the following equation for W_{LD}
$${L}_{EXT} \leq \frac{{λ}^{2}}{2 {W}_{LD}} .$$

18. The laser light source device according to claim 1, wherein the laser light source device further includes a temperature compensation unit that compensates for a resonator length changed depending on change of ambient temperature of a resonator of the laser light source or an external resonator formed by the laser light source and the first optical device.

19. The laser light source device according to claim 1, wherein the laser light source device further includes a λ/4 wavelength plate that intercepts a beam entering from the outside of the optical member, and the λ/4 wavelength plate is interposed between the partial reflection mirror and the recording medium and is provided to contact a wall of the optical member.

20. The laser light source device according to claim 1, wherein the beam detection unit calculates a Modulation Transfer Function by calculating contrast of a pattern of a received beam from signals detected in the plurality of regions.
